(19) United States
(12) Patent Application Publication
(10) Pub. No.: US 2004/0054971 A1
(43) Pub. Date: Mar. 18, 2004

(54) System and method for managing patent documents

(76) Inventors: Chung-I Lee, Tu-chen (TW); Chien-Fa Yeh, Tu-chen (TW); Yueshu Xie, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/285,751

(22) Filed: Oct. 31, 2002

(30) Foreign Application Priority Data
Sep. 17, 2002 (TW) 91121182

(51) Int. Cl. G06F 17/00

(52) U.S. Cl. 715/523

(57) ABSTRACT

A system for managing patent documents includes a user processing module (113) for designating names of source patent documents in image format and a name of a destination document in image format, a format converting module (115) for converting the source patent documents into the destination document, and a local storage (111) for storing the source patent documents and the destination document. A related method includes: (a) receiving a user order for generating a destination document in a designated image format, the user order comprising names of source patent documents in different image formats and a name of the destination document; (b) generating an empty destination document; (c) loading one source patent document; (d) adding the source patent document to the destination document; (e) returning to step (c) until all source patent documents have been added to the destination document; and (f) storing the destination document to a storage.

### BACKGROUND OF THE INVENTION

1. Field of the Invention

The present invention relates to a system and method for managing patent documents in electronic form, and especially relates to a system and method for managing distributed patent documents in image format.

2. Background of the Invention

The governments of many countries now provide access to their registered patent documents via Internet websites linking to patent databases. Detailed information on a patent is thus available in electronic form. Such information includes a specification and drawing figures. The information is invariably divided into several electronic patent documents, with each patent document comprising one page of the patent. Formats of these electronic patent documents also vary. Typically, the patent documents are stored in the patent database in image format. Users at a remote Internet terminal must read each patent page by page. Printing of each patent must also be done page by page. This is very laborious and time-consuming, especially considering that some patents comprise hundreds of pages. Typically, when a patent is downloaded from the database, a plurality of distributed patent documents in various image formats is stored in the user's local storage.

Recently, format conversion technology has developed significantly. A user can designate a name of a source file required for conversion, and a name of a destination file. A conversion program then executes the conversion from the source file to the destination file. For example, U.S. Pat. No. 6,385,606 entitled “File format conversion method, and file system, information processing system, electronic commerce system using the method” discloses a method for converting an original file having one format into a destination file having another format.

The above-described format conversion technology can accomplish conversion between formats for a variety of patent documents. But the technology only converts one format file into another format file. The technology does not adequately address the problem of processing and managing numerous patent documents that make up each single patent.

### SUMMARY OF THE INVENTION

Accordingly, an objective of the present inversion is to provide a system for managing patent documents that can convert a plurality of patent documents of one patent into a single destination document.

Another objective of the present invention is to provide a method for converting a plurality of various format patent documents of one patent into a single destination document.

In order to achieve the first above-mentioned objective, a system for managing patent documents in accordance with a preferred embodiment of the present invention comprises a plurality of client computers connected with a file server. Each client computer comprises a user processing module, a format converting module and a local storage. The user processing module has the function of receiving processing orders of a user, and is used for designating names of source patent documents in image format and a name of a destination document in image format. The format converting module has the function of converting a plurality of documents in different image formats into a document in a designated image format, and is used for converting the source patent documents into the destination document. The local storage stores the source patent documents and the destination document. The file server stores patent documents downloaded from intellectual property information websites.

In order to achieve the second above-mentioned objective, a method for managing patent documents in accordance with a preferred embodiment of the present invention comprises the steps of: (a) receiving a user order for generating a destination document in a designated image format, the user order comprising names of source patent documents in different image formats and a name of the destination document; (b) generating an empty destination document; (c) loading one source patent document; (d) adding the source patent document to the destination document; (e) returning to step (c) until all source patent documents have been added to the destination document; and (f) storing the destination document to a storage.

Furthermore, in order to achieve the above-mentioned objectives, a system and a method each in accordance with a respective alternative embodiment of the present invention are also provided.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for managing patent documents in accordance with a preferred embodiment of the present invention, the system comprising a plurality of client computers and a file server;

FIG. 2 is a schematic block diagram illustrating conversion between source patent documents and a single destination document;

FIG. 3 is a flow chart of converting source patent documents into a destination document in accordance with a preferred embodiment of the present invention;

FIG. 4 is a schematic diagram of a system for managing patent documents in accordance with an alternative embodiment of the present invention, the system comprising a client computer and a file server; and

FIG. 5 is a flow chart of converting source patent documents into a destination document in accordance with an alternative embodiment of the present invention.

### DETAILED DESCRIPTION OF PREFERRED EMBODIMENTS OF THE INVENTION

Reference will now be made to the drawings to describe the present invention in detail.

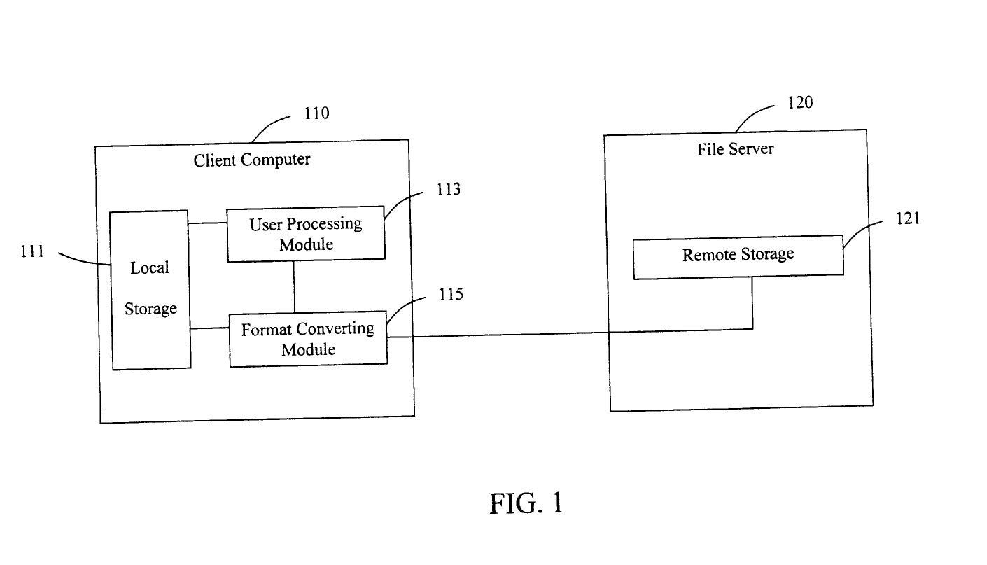

FIG. 1 is a schematic diagram of a system for managing patent documents in accordance with a preferred embodiment of the present invention. The system comprises a plurality of client computers 110 (only one shown) connected with a file server 120.

The file server 120 comprises a remote storage 121. The remote storage 121 stores all unstructured documents, including TIFF (Tag Image File Format) documents, JPEG (Joint Photographic Expert Group) documents, GIF (Graphic Interexchange Format) documents and PDF (Portable Document Format) documents. Patent documents downloaded from IP (intellectual property) information websites are invariably in one or more of the above-mentioned image formats. A single patent downloadable from an IP information website invariably comprises a plurality of patent documents in image format. Each patent document stores part of the entire patent. These patent documents are randomly stored in the remote storage 121 of the file server 120 when they are downloaded from the IP information website.

Each client computer 110 is used for receiving user orders, and displaying results of execution of the user orders. The client computer 10 comprises a user processing module 113, a format converting module 115, and a local storage 111. The local storage 111 is used for storing destination documents that have been converted from source documents. The user processing module 113 connects with the local storage 111, and comprises a GUI (Graphical User Interface) for receiving user orders to convert source patent documents in image format into a destination document in image format. The user processing module 113 controls all components of the system to effect the conversion. The format converting module 115 loads the source patent documents stored in the remote storage 121, converts the source patent documents into a PDF document, and stores the PDF document in the local storage 111 for further execution.

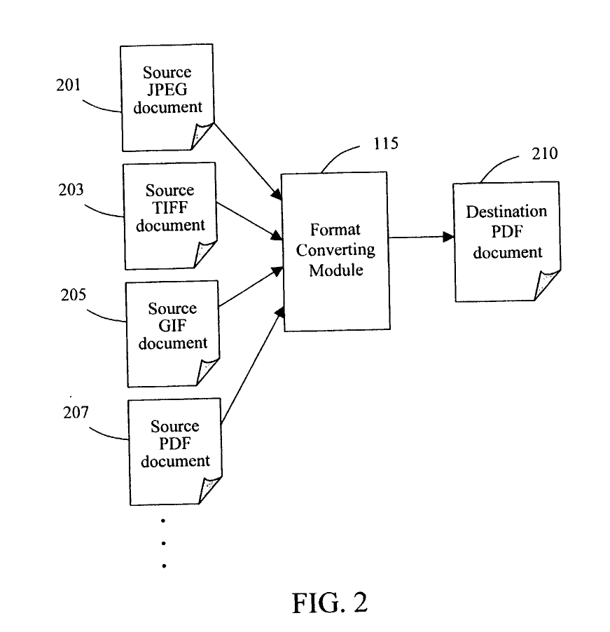

FIG. 2 is a schematic block diagram illustrating conversion between source patent documents and a single destination document. The user can designate names of the source patent documents and the destination document via the GUI of the user processing module 113. The source patent documents are stored in the remote storage 121, and comprise source JPEG documents 201, source TIFF documents 203, source GIF documents 205 and source PDF documents 207. The format converting module 115 then converts these source patent documents into a destination PDF document 210. The user can specify an order in which the source patent documents appear in the destination PDF document 210 via the GUI of the user processing module 113.

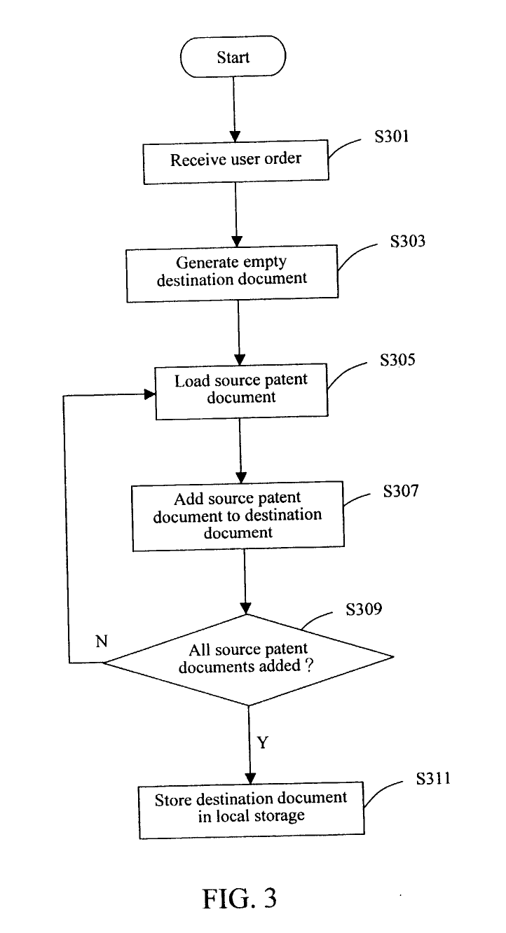

FIG. 3 is a flow chart of converting source patent documents into a destination document in accordance with a preferred embodiment of the present invention. Firstly, in step S301, the user processing module 113 receives a user order via the GUI. The user order includes names of the source patent documents, or a name of a folder in which all the source patent documents are stored. The user can designate a name and location of the destination document via the GUI. Alternatively, the destination document is stored in a default folder and under a default name such as the patent number of the source patent documents. The user can also specify, in the user order, an order in which the source patent documents are to appear in the destination document.

In step S303, the format converting module 115 generates an empty destination document in PDF format. In step S305, the format converting module 115 loads one source patent document. In step S307, the format converting module 115 adds the source patent document to the destination document. In step S309, the format converting module 115 determines whether all the source patent documents have been added to the destination document. If all the source patent documents have been added to the destination document, in step S311, the format converting module 115 stores the destination document in the local storage 111, and the user processing module 113 displays the destination document in PDF format for the user via the GUI. If any source patent documents have not been added to the destination document, the procedure returns to step S305.

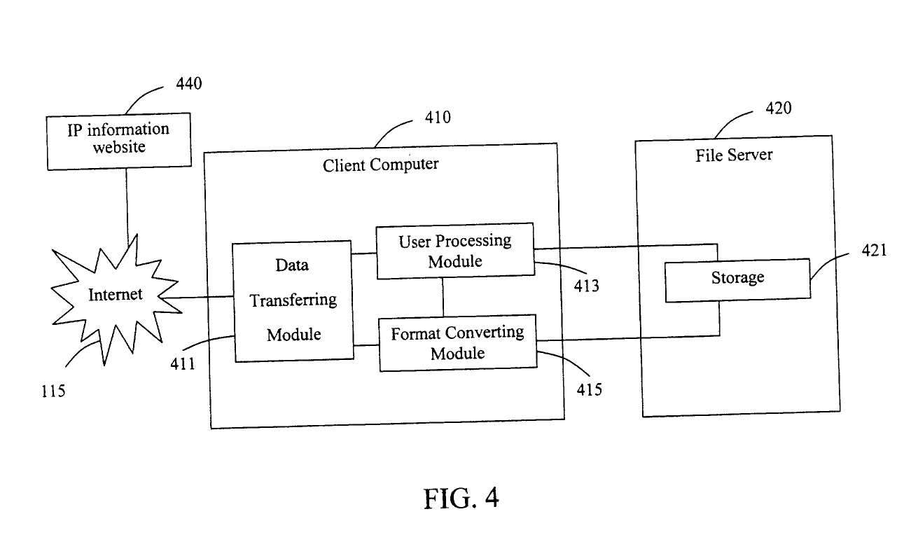

FIG. 4 is a schematic diagram of a system for managing patent documents in accordance with an alternative embodiment of the present invention. The system comprises a plurality of client computers 410 (only one shown) connected with a file server 420. Each client computer 410 connects with IP information websites 440 (only one shown) via the Internet 115. The file server 420 comprises a storage 421. The functions of the file server 420 and the storage 421 are the same as the functions of the file server 120 and the remote storage 121 described above in relation to FIG. 1.

Each client computer 410 is used for receiving user orders, and displaying results of execution of the user orders. The client computer 410 comprises a data transferring module 411, a user processing module 413, and a format converting module 415. The data transferring module 411 connects with the IP information websites 440 via the Internet 115, downloads patent documents from the IP information websites 440, and sends the downloaded patent documents to the format converting module 415. The user processing module 413 receives data downloading orders from users, and sends the data downloading orders to the data transferring module 411. The user processing module 413 controls all components of the system to effect conversion of downloaded patent documents into a single destination document. The format converting module 415 converts a plurality of source patent documents of a single patent downloaded from one IP information website 440 into a destination PDF document, assigns a designated name or a default name to the PDF document, and stores the PDF document in the storage 421 of the file server 420 for further execution.

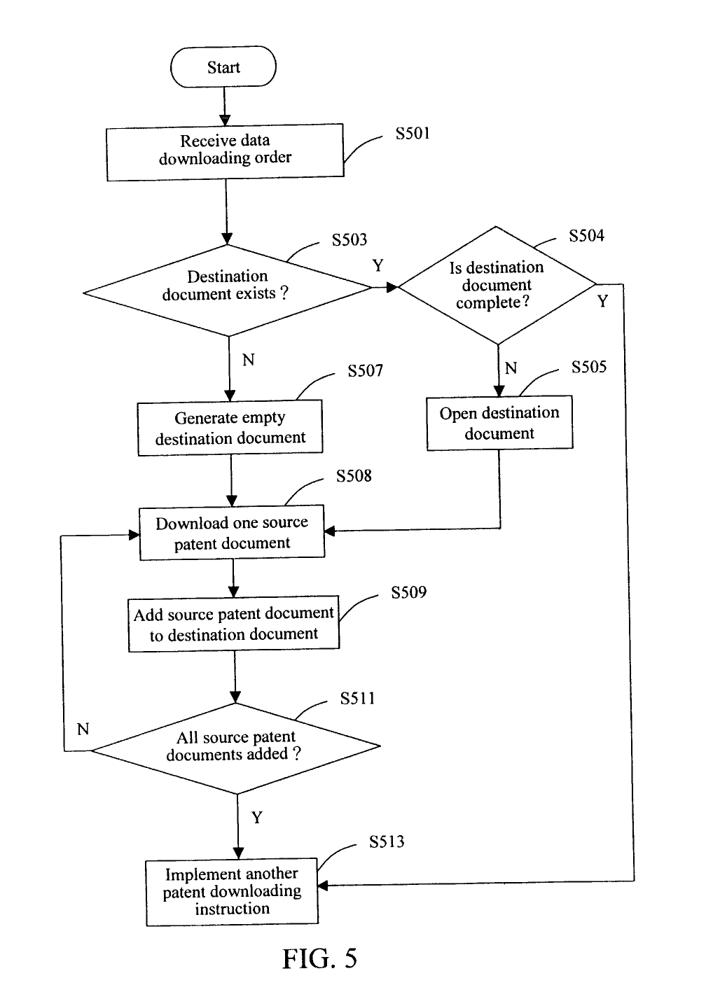

FIG. 5 is a flow chart of converting source patent documents into a destination document in accordance with an alternative embodiment of the present invention. Firstly, in step S501, the user processing module 413 receives a data downloading order via the GUI. The user processing module 413 divides the data downloading order into several patent downloading instructions, each patent downloading instruction corresponding to a respective patent. In step S503, the user processing module 413 searches for a destination document matching a particular patent downloading instruction in the storage 421, and determines whether the destination document exists.

If the destination document does not exist in the storage 421, in step S507, the format converting module 415 generates an empty destination document in PDF format, and an accompanying document for recording a summary of the destination document. The summary includes information such as a time of generation of the destination document, a time of modification of the destination document, and a content of the destination document. In step S508, the data transferring module 411 receives a patent downloading instruction from the user processing module 413, and implements the instruction to download one source patent document matching the instruction from the corresponding IP information website 440. In step S509, the format converting module 415 adds the source patent document downloaded by the data transferring module 411 to the destination document. In step S511, the format converting module 415 determines whether all source patent documents of the patent matching the patent downloading instruction have been added to the destination document. If all said source patent documents have been added to the destination document, in step S513, the user processing module 413 stores the time of generation of the destination document and the content of the destination document in the accompanying summary document, and implements another patent downloading instruction. If any said source patent documents have not been added to the destination document, the procedure returns to step S508.

If the destination document exists in the storage 421, in step S504, the user processing module 413 determines whether the destination document is complete in accordance with its accompanying summary document. If the destination document is complete, the procedure proceeds directly to step S513 described above. If the destination document is not complete, in step S505, the user processing module 413 opens the destination document, whereupon the procedure proceeds to step S508 described above.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for managing patent documents, the system comprising a user processing module, a format converting module and a storage, wherein:
the user processing module has the function of receiving processing orders of a user, and is used for designating names of source patent documents in image format and a destination document in image format;
the format converting module has the function of converting a plurality of documents in different image formats into a document in a designated image format, and is used for converting the source patent documents into the destination document; and
the storage stores the source patent documents and the destination document.

2. The system as claimed in claim 1, wherein the source patent documents are in any one or more of the following formats: Tag Image File Format (TIFF), Joint Photographic Expert Group (JPEG), Graphic Interexchange Format (GIF) and Portable Document Format (PDF).

3. The system as claimed in claim 1, wherein the destination document is in PDF format.

4. A system for managing patent documents, the system comprising a user processing module, a format converting module and a data transferring module, wherein:
the user processing module connects with the data transferring module, and is used for receiving processing orders of a user including orders for downloading documents from the Internet, and for designating a name and location of a destination document in image format;
the format converting module has the function of converting a plurality of documents in different image formats into a document in a designated image format, and is used for converting source patent documents downloaded from the Internet into the destination document; and
the data transferring module downloads source patent documents from intellectual property information websites via the Internet in accordance with the user order.

5. The system as claimed in claim 4, wherein the source patent documents are in any one or more of the following formats: Tag Image File Format (TIFF), Joint Photographic Expert Group (JPEG), Graphic Interexchange Format (GIF) and Portable Document Format (PDF).

6. The system as claimed in claim 4, wherein the destination document is in PDF format.

7. A method for managing patent documents, the method comprising the steps of:
(a) receiving a user order for generating a destination document in a designated image format, the user order comprising names of source patent documents in different image formats and a name of the destination document;
(b) adding the source patent documents to the destination document; and
(c) storing the destination document to a storage.

8. The method as claimed in claim 7, wherein the source patent documents are in any one or more of the following formats: Tag Image File Format (TIFF), Joint Photographic Expert Group (JPEG), Graphic Interexchange Format (GIF) and Portable Document Format (PDF).

9. The method as claimed in claim 7, wherein the destination document is in PDF format.

10. The method as claimed in claim 7, wherein step (b) further comprises the steps of:
(b1) generating an empty destination document;
(b2) loading one source patent document;
(b3) adding the source patent document to the destination document; and
(b4) returning to step (b2) until all source patent documents have been added to the destination document.

11. A method for managing patent documents, the method comprising the steps of:
receiving a user order for downloading patent documents, the order comprising a designated name of a destination document in a designated image format;
receiving source patent documents in different image formats from the Internet, and sending the source patent documents to a format converting module;
generating an empty destination document;
adding the source patent documents to the destination document; and storing the destination document to a storage.

12. The method as claimed in claim 11, wherein the destination document is in PDF format.
